(19) United States
(12) Patent Application Publication
(10) Pub. No.: US 2017/0171595 A1
(43) Pub. Date: Jun. 15, 2017

(54) DATA TRANSMISSION CONTROLLING DEVICE AND DATA TRANSMISSION CONTROLLING METHOD FOR A MOBILE DEVICE

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Yuan TIAN, Beijing (CN)

(73) Assignees: LE HOLDINGS (BEIJING) CO., LTD., Beijing (CN); LE SHI INTERNET INFORMATION & TECHNOLOGY CORP., BEIJING, Beijing (CN)

(21) Appl. No.: 15/243,227

(22) Filed: Aug. 22, 2016

Related U.S. Application Data
(63) Continuation of application No. PCT/CN2016/089517, filed on Jul. 10, 2016.

(30) Foreign Application Priority Data
Dec. 15, 2015 (CN) 201510931913X

(51) Int. Cl. H04N 21/422; H04N 21/41; H04N 21/472; G06F 3/01; H04N 21/845; H04N 21/637; G06F 3/0488; G06F 3/0489; H04N 21/436; H04N 21/65

(52) U.S. Cl. CPC H04N 21/42204; H04N 21/436; H04N 21/4126; H04N 21/47217; H04N 21/65; H04N 21/8456; H04N 21/637; G06F 3/04883; G06F 3/0489; G06F 3/017

(57) ABSTRACT

An embodiment of the present disclosure relates to the technical field of data transfer between a mobile device and a television, and discloses a data transmission controlling device for a mobile device and a data transmission controlling method for a mobile device. The data transmission controlling device for a mobile device includes: a detector, configured to detect at least one of a moving track of the mobile device, a sliding gesture on a screen of the mobile device, and a key instruction of the mobile device; a first transceiver; and a processor, configured to control the first transceiver to send a uniform resource locator of a video currently being played on the mobile device and a timestamp of the current playback, when at least one of a particular moving track, a particular sliding gesture, and a particular key instruction is detected. With a technical solution provided by the present disclosure, a video being played on a mobile device can be played on a television, so that a user can conveniently use a television to play a video being played on a mobile phone.

### CROSS REFERENCE TO RELATED APPLICATIONS

The present disclosure is a continuation of International Application No. PCT/CN2016/089517 filed on Jul. 10, 2016, which is based on and claims priority of Chinese Application No. 201510931913.X filed on Dec. 15, 2015, the entire contents of all of which are incorporated herein by reference.

### TECHNICAL FIELD

In one aspect, the present disclosure relates to technology fields of data transferring between a mobile device and a television, and particularly to a data transmission controlling device for a mobile device and a data transmission controlling method for a mobile device.

### BACKGROUND

At present, users have been used to watching video on mobile devices, especially watching video shared by their friends by using handheld terminals (for example, mobile phones or pads). Users have to watch video on handheld terminals if their friends share video by using some applications as those applications cannot be executed by a computer. Besides, some applications push some news videos to users via handheld terminals, and users can watch these news videos on handheld terminals by simply tapping on the links of news videos to enter the watching pages. It would be more troublesome if the user has to turn on a computer to search for a related video.

However, the screen size of a handheld terminal, especially a mobile phone, is limited. Even large-screen of mobile phones currently available on the selling market are not having the ability to compete with the screen of televisions. Therefore, watching videos on mobile phones cannot give users better experience.

A video that a user has access to by using a handheld terminal can be watched only on the handheld terminal, and cannot be watched on a television directly. If the user wants to watch the video on a television, the user needs to find a uniform resource locator (URL) of the video, then search for the video according to the address by using a computer, and connect a television to the computer via a high definition cable as a display screen of the computer. In this way, the user can watch the video on the television. Apparently, this process is rather troublesome.

### SUMMARY

An objective of some embodiments of the present invention is to provide a data transmission controlling device for a mobile device and a data transmission controlling method for a mobile device so as to solve the problem of how to play a video on a handheld terminal by using a television.

To achieve the foregoing objective, an embodiment of the present disclosure provides a data transmission controlling device for a mobile device. The data transmission controlling device includes:

a detector, configured to detect at least one of a moving track of the mobile device, a sliding gesture on a screen of the mobile device, and a key instruction of the mobile device; a first transceiver; and a processor, configured to control the first transceiver to send a uniform resource locator of a video currently being played on the mobile device and a timestamp of the current playback, in a case where the detector detects that the moving track is a particular moving track, that the sliding gesture is a particular sliding gesture, and/or that the key instruction is a particular key instruction.

Correspondingly, an embodiment of the present disclosure further provides a data transmission controlling method for a mobile device. The data transmission controlling method includes: detecting at least one of a moving track of the mobile device, a sliding gesture on a screen of the mobile device, or a key instruction of the mobile device; and sending a uniform resource locator of a video currently being played on the mobile device and a timestamp of the current playback, in a case where it is detected that the moving track is a particular moving track, that the sliding gesture is a particular sliding gesture, and/or that the key instruction is a particular key instruction.

According to the foregoing technical solution, in an embodiment of the present disclosure, a moving track of a mobile device and/or a sliding gesture of a user on a screen of the mobile device are detected, and in a case where a particular moving track and/or a particular sliding gesture is detected, a uniform resource locator of a video currently being played on the mobile device and a timestamp of the current playback are sent to a television, so as to play, on the television, the video currently being played on the mobile device, so that a user can conveniently use a television to play a video being played on a mobile phone.

Other features and advantages of the present disclosure will be described in detail in the detailed embodiments below.

### BRIEF DESCRIPTION OF THE DRAWINGS

The accompanying drawings are used to provide a further understanding of the present disclosure, and constitute a part of the specification, which are used to explain the present disclosure in combination with the detailed embodiments below, and do not constitute a limitation to the present disclosure. In the accompanying drawings:

FIG. 1 is a block diagram of a data transmission controlling device for a mobile device according to an embodiment of the present disclosure;

FIG. 2 is a block diagram of a device for controlling playback on a television by a user according to an embodiment of the present disclosure;

FIG. 3 illustrates a system for data transfer between a mobile device and a television according to an embodiment of the present disclosure;

FIG. 4 is a diagram illustrating signaling interaction between a mobile device and a television according to an embodiment of the present disclosure;

FIG. 5 is a flowchart of a data transmission controlling method for a mobile device according to an embodiment of the present disclosure; and

FIG. 6 is a flowchart of a method for controlling playback on a television according to an embodiment of the present disclosure.

### DETAILED DESCRIPTION

Specific implementation manners of some embodiments of the present disclosure are described in detail below with reference to the accompanying drawings. It should be understood that the specific implementation manners described herein are merely for the purpose of illustrating and explaining the present disclosure, but are not intended to limit the present disclosure.

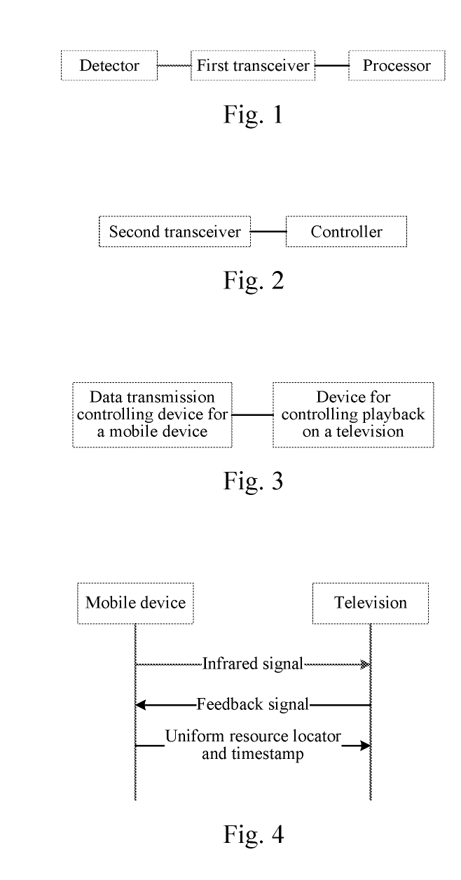

FIG. 1 is a block diagram of a data transmission controlling device for a mobile device according to an embodiment of the present disclosure. As shown in FIG. 1, the data transmission controlling device includes a detector, a first transceiver, and a processor. The detector is configured to detect at least one of a moving track of the mobile device, a sliding gesture on a screen of the mobile device, or a key instruction of the mobile device. The processor is configured to control the first transceiver to send a uniform resource locator of a video currently being played on the mobile device and a timestamp of the current playback, in a case where the detector detects that the moving track is a particular moving track, that the sliding gesture is a particular sliding gesture, and/or that the key instruction is a particular key instruction.

As long as the detector detects one or more of the particular moving track, the particular sliding gesture, or the particular key instruction, the processor controls the first transceiver to send the uniform resource locator of the video currently being played on the mobile device and the timestamp of the current playback. In a case where a user holding the mobile device performs a particular action (for example, swiping the mobile device towards a television), the detector detects a particular moving track corresponding to the particular action. In a case where the user uses a finger to slide on the screen of the mobile device to perform a particular gesture, the detector detects a particular sliding gesture corresponding to the particular gesture. In a case where the user presses a particular key (for example, presses 123456), the detector detects a corresponding particular key instruction.

Only if the detector detects one of the particular moving track, the particular sliding gesture, or the particular key instruction, the processor controls the first transceiver to send the uniform resource locator of the video currently being played on the mobile device and the timestamp of the current playback. Generally, the user does not send an instruction by using the three methods at the same time. However, if one of the methods does not work, another method may be used to send an instruction. However, the user may also use any two or all of the three methods at the same time.

The detector includes at least one of a motion detection apparatus, a gesture recognition apparatus, or a key unit. The motion detection apparatus is configured to detect the moving track of the mobile device. The gesture recognition apparatus is configured to detect the sliding gesture on the screen of the mobile device. The key unit is configured to receive the key instruction.

It should be understood by a person skilled in the art that in a case where the detector includes the motion detection apparatus, the gesture recognition apparatus, and the key unit, the detector can detect the moving track of the mobile device, the sliding gesture on the screen of the mobile device, and the key instruction of the mobile device; if the detector includes only one or two of them, the detector can detect corresponding actions or information only. For example, if the detector includes the motion detection apparatus and the gesture recognition apparatus, the detector can detect only the moving track of the mobile device and the sliding gesture on the screen of the mobile device.

The above motion detection apparatus may determine the moving track of the mobile device by sensing three-dimensional angles of movement of the mobile device (including a front-to-back angle, an up-to-down angle, and a left-to-right angle), or may determine the moving track of the mobile device by virtue of a moving velocity of the mobile device and an action duration. The sensing of the three-dimensional angles of movement of the mobile device may be implemented by using a gyroscope, the sensing of the moving velocity of the mobile device may be implemented by using a velocity sensor, and the action duration may be obtained by calculating a time interval between neighboring stationary states of the mobile device by using a timer. The above gesture recognition apparatus may obtain the sliding gesture by means of pixel capturing. In addition, it should be understood by a person skilled in the art that the moving track or the sliding gesture performed by the user has an error, an action similarity and a gesture similarity may be set correspondingly, and in a case where the detected moving track and sliding gesture and a preset moving track and sliding gesture satisfy a given similarity, it is considered that the user performs a particular moving track and a particular sliding gesture.

In addition, it should be understood by a person skilled in the art that if the user intends to synchronize a video currently being played on the mobile device to a television for playback by means of the above technical solution, the user needs to set a particular moving track, a particular sliding gesture, and a particular key instruction in advance. The three may be set according to requirements. Furthermore, the precondition of the above technical solution is that the user is watching a video on the mobile device.

FIG. 2 is a block diagram of a device for controlling playback on a television by a user according to an embodiment of the present disclosure. As shown in FIG. 2, the device includes a second transceiver and a controller. The second transceiver is configured to receive a uniform resource locator of a video and a timestamp of the current playback. The controller is configured to control the television to play the video at the received uniform resource locator starting from a time identified by the timestamp, in a case where the uniform resource locator and the timestamp are received.

It can be seen that the second transceiver shown in FIG. 2 is a transceiver at the television side, and the first transceiver shown in FIG. 1 is a transceiver at the mobile device side. Herein, the first transceiver and the second transceiver are generally wireless transceivers, which may transmit and receive messages via WiFi, Bluetooth, or the like. In a case where the second transceiver receives the uniform resource locator of the video and the timestamp of the current playback from the mobile device, the television is controlled to play the video at the uniform resource locator starting from the time identified by the timestamp, thereby synchronizing a video being played on the mobile device to the television for playback.

FIG. 3 illustrates a system for data transfer between a mobile device and a television according to an embodiment of the present disclosure. As shown in FIG. 3, the system includes the data transmission controlling device for a mobile device as described above and the device for controlling playback on a television as described above.

In addition, the system for data transfer between a mobile device and a television further includes a matching unit, configured to pair a mobile device and a television that are in a same local area network, where information transmission and reception are performed between the paired mobile device and television, that is, a video being played on the mobile device is synchronized to a paired television for playback. Herein, all mobile devices and televisions in a same local area network may be paired. The purpose of pairing is to perform information transmission and reception only between the paired mobile device and television. For example, if pairing is not performed, the video being played on the mobile device may be synchronized to a television of a neighbor for playback. Certainly, pairing may also be performed according to an identifier. For example, a mobile device and a television that have a same identifier are paired. The identifier herein may represent, for example, a mobile device and a television that are of a same brand. In this way, information transmission and reception can be performed only between a mobile device and a television that are of a same brand.

Specifically, the mobile device side and the television side may each be provided with one matching unit, so that either the mobile device or the television, once connected to WiFi, searches in the same local area network, and performs pairing in a case where a corresponding device (television or mobile device) is found. For example, in a case where a WiFi device in a household has been turned on, if a mobile device is connected to WiFi, the matching unit in the mobile device searches in the current local area network. If the mobile device finds a television that is connected to the same WiFi, that is, located in a same local area network as the mobile device, the mobile device is paired with the television.

Certainly, because there may be multiple televisions in a household, it is possible that in a case where the detector in the mobile device detects the particular moving track or the particular sliding gesture or the particular key instruction, the processor sends a uniform resource locator of a video currently being played on the mobile device and a timestamp of the current playback to multiple televisions for playback, which undoubtedly causes inconvenience to other household members who are watching the television. This problem can be resolved by using infrared, which will be described in detail below.

In a case where there are multiple televisions, the data transmission controlling device for a mobile device further includes a mobile-device infrared transceiver; and the device for controlling playback on a television further includes a television infrared transceiver, where the processor in the data transmission controlling device uses the first transceiver to send, to a television that receives the infrared signal, a uniform resource locator of a video currently being played on the mobile device and a timestamp of the current playback, according to exchange of an infrared signal between the mobile-device infrared transceiver and the television infrared transceiver.

It should be understood by a person skilled in the art that the infrared transceiver has a particular transmission range. For example, the television remote control needs to be within a certain angle range with respect to the television in order to send a remote control signal to the television. Therefore, the television to which the mobile device intends to send the uniform resource locator of the video currently being played on the mobile device and the timestamp of the current playback can be determined by means of exchange of an infrared signal between the mobile-device infrared transceiver and the television infrared transceiver.

The sending the uniform resource locator and the timestamp of the current playback according to exchange of an infrared signal between the mobile-device infrared transceiver and the television infrared transceiver includes: controlling, by the processor in the data transmission controlling device, the mobile-device infrared transceiver to send an infrared signal, in a case where the detector detects that the moving track is a particular moving track, that the sliding gesture is a particular sliding gesture, and/or that the key instruction is a particular key instruction; controlling, by the controller in the device for controlling playback on a television, the second transceiver to send a feedback signal, in a case where the television infrared transceiver receives the infrared signal; and sending, by the processor in the data transmission controlling device, the uniform resource locator of the video currently being played on the mobile device and the timestamp of the current playback to a television that sends the feedback signal, in a case where the first transceiver receives the feedback signal.

Only in a case where the mobile-device infrared transceiver faces towards the television infrared transceiver and is at a given angle (similar to an infrared transceiver in a television remote control and an infrared transceiver in a television in a household nowadays), an infrared signal sent by the mobile-device infrared transceiver can be received by the television infrared transceiver. In a case where the television infrared transceiver (the television side) receives the infrared signal, the controller uses the second transceiver to send a feedback signal to the mobile device side. Only in this case, the data transmission controlling device for a mobile device sends the uniform resource locator of the video currently being played on the mobile device and the timestamp of the current playback to the television side. Herein, a television to which the video currently being played on the mobile device is to be synchronized for playback is determined by using an angle range of infrared.

It should be understood by a person skilled in the art that the feedback signal described above may include a unique identifier of a television, and the processor in the data transmission controlling device for the mobile device sends the uniform resource locator of the video currently being played on the mobile device and the timestamp of the current playback to the television having the unique identifier according to the unique identifier. For example, in a case where there are multiple televisions in a household, a unique identifier may be set for each television (for example, #1, #2, #3, and so on). The unique identifier is included in the feedback signal fed back by the television side to the mobile device side, so that the mobile device side can learn the television from which the feedback signal is sent.

The mobile device described in an embodiment of the present disclosure may be a handheld terminal, particularly, a mobile phone, a pad, or the like.

FIG. 4 is a diagram illustrating signaling interaction between a mobile device and a television according to an embodiment of the present disclosure. As shown in FIG. 4, when the mobile device intends to synchronize a video being played thereon to a television for playback, the mobile device sends an infrared signal to the television. Upon receiving the infrared signal, the television sends a feedback signal to the mobile device. Upon receiving the feedback signal, the mobile device learns the television that receives the infrared signal. Then, the mobile device sends a uniform resource locator of the video being played thereon and a timestamp to the corresponding television (that is, the television that sends the feedback signal) for playback.

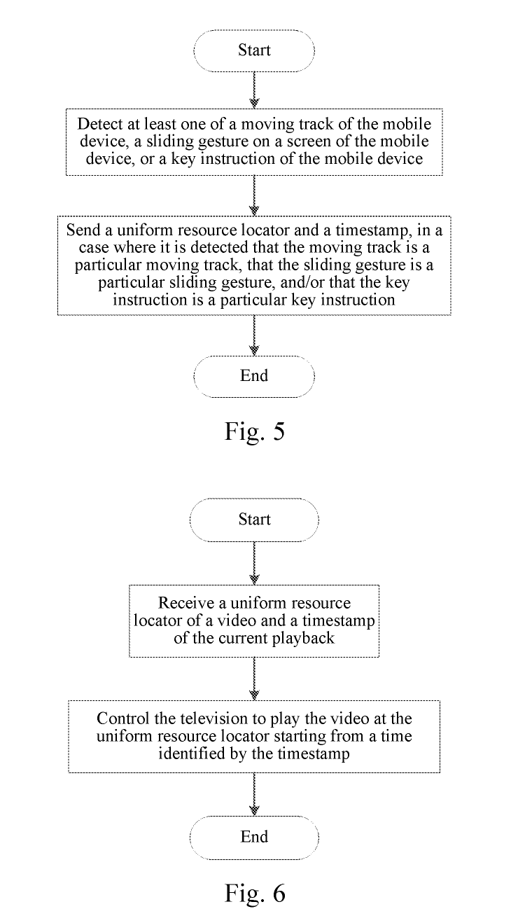

FIG. 5 is a flowchart of a data transmission controlling method for a mobile device according to an embodiment of the present disclosure. As shown in FIG. 5, the data transmission controlling method includes: detecting at least one of a moving track of the mobile device, a sliding gesture on a screen of the mobile device, or a key instruction of the mobile device; and sending a uniform resource locator of a video currently being played on the mobile device and a timestamp of the current playback, in a case where it is detected that the moving track is a particular moving track, that the sliding gesture is a particular sliding gesture, and/or that the key instruction is a particular key instruction.

It should be noted that specific details and benefits of the data transmission controlling method for a mobile device that is provided in this embodiment of the present disclosure are similar to those of the data transmission controlling device for a mobile device that is provided by the present disclosure, and the details are not described herein again.

FIG. 6 is a flowchart of a method for controlling playback on a television according to an embodiment of the present disclosure. As shown in FIG. 6, the method includes: receiving a uniform resource locator of a video and a timestamp of the current playback; and controlling the television to play the video at the uniform resource locator starting from a time identified by the timestamp.

It should be noted that specific details and benefits of the method for controlling playback on a television that is provided in this embodiment of the present disclosure are similar to those of the device for controlling playback on a television that is provided by the present disclosure, and the details are not described herein again.

Although preferable implementation manners of some embodiments of the present disclosure have been described in detail above with reference to the accompanying drawings, the present disclosure is not limited to specific details in the foregoing implementation manners. Various simple variations can be made to the technical solutions of the present disclosure within the scope of the technical idea of the present disclosure, and such simple variations all fall within the protection scope of the present disclosure.

It should be further noted that the specific technical features described in the foregoing specific implementation manners can be combined in any appropriate manner as long as no conflict occurs. To avoid unnecessary repetition, various possible combination manners will not be described in the present disclosure.

In addition, various different implementation manners of the present disclosure may also be combined arbitrarily. Such combinations shall also be considered as the content disclosed by the present disclosure as long as these combinations do not depart from the concept of the present disclosure.

What is claimed is:

1. A data transmission controlling device for a mobile device, comprising:
a detector, configured to detect at least one of a moving track of the mobile device, a sliding gesture on a screen of the mobile device and a key instruction of the mobile device;
a first transceiver; and
one or more processors, coupled with the detector and the first transceiver, configured to control the first transceiver to send a uniform resource locator of a video currently being played on the mobile device and a timestamp of the current playback, when the detector detects one of the following cases:
that the moving track is a specific moving track;
or/and that the sliding gesture is a specific sliding gesture; or/and
that the key instruction is a specific key instruction.

2. The data transmission controlling device according to claim 1, wherein the detector comprises at least one of the following:
a motion detection apparatus, configured to detect the moving track of the mobile device;
a gesture recognition apparatus, configured to detect the sliding gesture on the screen of the mobile device; or
a key receiver, configured to receive the key instruction.

3. The data transmission controlling device according to claim 1, wherein the one or more processors are configured to pair the mobile device with a television that are in a same local area network,
wherein data transmission and reception are performed between the paired mobile device and television.

4. The data transmission controlling device according to claim 1, wherein when there are multiple televisions and at least one of the multiple televisions comprises a television infrared transceiver,
the data transmission control device further comprises a mobile-device infrared transceiver;
wherein the one or more processors use the first transceiver to send, according to exchange of an infrared signal between the mobile-device infrared transceiver and a television infrared transceiver, a uniform resource locator of a video currently being played on the mobile device and a timestamp of the current playback to a television that receives the infrared signal.

5. The data transmission controlling device according to claim 4, wherein to send the uniform resource locator and the timestamp of the current playback according to exchange of an infrared signal between the mobile-device infrared transceiver and the television infrared transceiver, the one or more processors are configured to:
control the mobile-device infrared transceiver to send an infrared signal, in a case where the detector detects that the moving track is a particular moving track, that the sliding gesture is a particular sliding gesture, and/or that the key instruction is a particular key instruction;
send the uniform resource locator of the video currently being played on the mobile device and the timestamp of the current playback to a television that sends a feedback signal to the mobile device, in a case where the first transceiver receives the feedback signal.

6. The data transmission controlling device according to claim 5, wherein the feedback signal comprises a unique identifier of a television, and wherein the one or more processors send the uniform resource locator of the video currently being played on the mobile device and the timestamp of the current playback to the television having the unique identifier according to the unique identifier.

7. A data transmission controlling method for a mobile device, comprising:
at the mobile device:
detecting at least one of a moving track of the mobile device, a sliding gesture on a screen of the mobile device and a key instruction of the mobile device; and
sending a uniform resource locator of a video currently being played on the mobile device and a timestamp of the current playback, when one of the following cases is detected:
that the moving track is a particular moving track;
that the sliding gesture is a particular sliding gesture; and
that the key instruction is a particular key instruction.

8. The data transmission controlling method according to claim 7, wherein the method comprises:
pairing, by the one or more processors, the mobile device with a television that are in a same local area network;
wherein data transmission and reception are performed between the paired mobile device and television.

9. The data transmission controlling method according to claim 7, wherein when there are multiple televisions and at least one of the multiple televisions comprises a television infrared transceiver, the data transmission control device further comprises a mobile-device infrared transceiver;
wherein the method comprises using, by the one or more processors, the first transceiver to send, according to exchange of an infrared signal between the mobile-device infrared transceiver and a television infrared transceiver, a uniform resource locator of a video currently being played on the mobile device and a timestamp of the current playback to a television that receives the infrared signal.

10. The data transmission controlling method according to claim 9, wherein to send the uniform resource locator and the timestamp of the current playback according to exchange of an infrared signal between the mobile-device infrared transceiver and the television infrared transceiver, the method comprises:
controlling, by the one or more processors, the mobile-device infrared transceiver to send an infrared signal, in a case where the detector detects that the moving track is a particular moving track, that the sliding gesture is a particular sliding gesture, and/or that the key instruction is a particular key instruction;
sending, by the one or more processors, the uniform resource locator of the video currently being played on the mobile device and the timestamp of the current playback to a television that sends a feedback signal to the mobile device, in a case where the first transceiver receives the feedback signal.

11. The data transmission controlling method according to claim 10, wherein the feedback signal comprises a unique identifier of a television, and wherein the method comprises:
sending, by the one or more processors, the uniform resource locator of the video currently being played on the mobile device and the timestamp of the current playback to the television having the unique identifier according to the unique identifier.
